(19) United States
(12) Patent Application Publication
(10) Pub. No.: US 2022/0058579 A1
(43) Pub. Date: Feb. 24, 2022

(54) VEHICLE REPAIR WORKFLOW AUTOMATION WITH NATURAL LANGUAGE PROCESSING

(71) Applicant: Mitchell International, Inc., San Diego, CA (US)

(72) Inventors: GeengYee Chong, San Diego, CA (US); Jerry Gastineau, San Diego, CA (US); Abhijeet Gulati, San Diego, CA (US)

(73) Assignee: Mitchell International, Inc., San Diego, CA (US)

(21) Appl. No.: 16/998,948

(22) Filed: Aug. 20, 2020

(51) Int. Cl. G06Q 10/10; G06Q 10/00; G06Q 40/08; G06Q 10/08; G06N 20/00; G06T 7/00; G06F 40/20

(52) U.S. Cl. CPC G06Q 10/10; G06Q 10/20; G06Q 40/08; G06Q 10/0875; G06T 2207/30248; G06T 7/0002; G06F 40/20; G06T 2207/20081; G06N 20/00

(57) ABSTRACT

Vehicle repair workflow automation with natural language processing is disclosed. One computer-implemented method comprises: providing images of a damaged vehicle as first input to a computer vision machine learning model, wherein the computer vision machine learning model has been trained with images of other damaged vehicles and corresponding vehicle repair operations; receiving first output of the computer vision machine learning model responsive to the first input, wherein the first output represents a plurality of the vehicle repair operations; providing the first output of the computer vision machine learning model to a natural language processing (NLP) machine learning model, wherein the NLP machine learning model has been trained with vehicle repair content comprising a plurality of vehicle repair procedures; and receiving second output of the NLP machine learning model responsive to the second input, wherein the second output comprises a recommended one of the plurality of the vehicle repair procedures.

### DESCRIPTION OF RELATED ART

The disclosed technology relates generally to systems for vehicle repair workflows, and more particularly, some embodiments relate to automation of those workflows.

### SUMMARY

A claimed solution rooted in computer technology overcomes problems specifically arising in the realm of computer technology.

In general, one aspect disclosed features a system, comprising: a hardware processor; and a non-transitory machine-readable storage medium encoded with instructions executable by the hardware processor to perform a method comprising: providing one or more images of a damaged vehicle as first input to a computer vision machine learning model, wherein the computer vision machine learning model has been trained with images of other damaged vehicles and corresponding vehicle repair operations; receiving first output of the computer vision machine learning model responsive to the first input, wherein the first output represents a plurality of the vehicle repair operations; providing the first output of the computer vision machine learning model to a natural language processing (NLP) machine learning model, wherein the NLP machine learning model has been trained with vehicle repair content comprising a plurality of vehicle repair procedures; and receiving second output of the NLP machine learning model responsive to the second input, wherein the second output comprises a recommended one of the plurality of the vehicle repair procedures.

Embodiments of the system may include one or more of the following features. In some embodiments, the method further comprises: generating a vehicle repair estimate based on the recommended one of the plurality of the vehicle repair procedures. In some embodiments, the method further comprises: providing the vehicle repair estimate as third input to the NLP machine learning model; and receiving third output of the NLP machine learning model responsive to the third input, wherein the third output comprises an accuracy score for the estimate. In some embodiments, the accuracy score indicates whether a line of the estimate is accurate or not accurate. In some embodiments, the accuracy score indicates whether a line of the estimate is necessary. In some embodiments, the accuracy score indicates whether a cost of a line of the estimate is above a corresponding predetermined threshold. In some embodiments, the third output of the NLP machine learning model comprises a vehicle repair procedure.

In general, one aspect disclosed features a non-transitory machine-readable storage medium encoded with instructions executable by a hardware processor of a computing component, the machine-readable storage medium comprising instructions to cause the hardware processor to perform a method comprising: providing one or more images of a damaged vehicle as first input to a computer vision machine learning model, wherein the computer vision machine learning model has been trained with images of other damaged vehicles and corresponding vehicle repair operations; receiving first output of the computer vision machine learning model responsive to the first input, wherein the first output represents a plurality of the vehicle repair operations; providing the first output of the computer vision machine learning model to a natural language processing (NLP) machine learning model, wherein the NLP machine learning model has been trained with vehicle repair content comprising a plurality of vehicle repair procedures; and receiving second output of the NLP machine learning model responsive to the second input, wherein the second output comprises a recommended one of the plurality of the vehicle repair procedures.

Embodiments of the non-transitory machine-readable storage medium may include one or more of the following features. In some embodiments, the method further comprises: generating a vehicle repair estimate based on the recommended one of the plurality of the vehicle repair procedures. In some embodiments, the method further comprises: providing the vehicle repair estimate as third input to the NLP machine learning model; and receiving third output of the NLP machine learning model responsive to the third input, wherein the third output comprises an accuracy score for the estimate. In some embodiments, the accuracy score indicates whether a line of the estimate is accurate or not accurate. In some embodiments, the accuracy score indicates whether a line of the estimate is necessary. In some embodiments, the accuracy score indicates whether a cost of a line of the estimate is above a corresponding predetermined threshold. In some embodiments, the third output of the NLP machine learning model comprises a vehicle repair procedure.

In general, one aspect disclosed features a computer-implemented method comprising: providing one or more images of a damaged vehicle as first input to a computer vision machine learning model, wherein the computer vision machine learning model has been trained with images of other damaged vehicles and corresponding vehicle repair operations; receiving first output of the computer vision machine learning model responsive to the first input, wherein the first output represents a plurality of the vehicle repair operations; providing the first output of the computer vision machine learning model to a natural language processing (NLP) machine learning model, wherein the NLP machine learning model has been trained with vehicle repair content comprising a plurality of vehicle repair procedures; and receiving second output of the NLP machine learning model responsive to the second input, wherein the second output comprises a recommended one of the plurality of the vehicle repair procedures.

Embodiments of the computer-implemented method may include one or more of the following features. Some embodiments comprise generating a vehicle repair estimate based on the recommended one of the plurality of the vehicle repair procedures. Some embodiments comprise providing the vehicle repair estimate as third input to the NLP machine learning model; and receiving third output of the NLP machine learning model responsive to the third input, wherein the third output comprises an accuracy score for the estimate. In some embodiments, the accuracy score indicates whether a line of the estimate is accurate or not accurate. In some embodiments, the accuracy score indicates whether a line of the estimate is necessary. In some embodiments, the accuracy score indicates whether a cost of a line of the estimate is above a corresponding predetermined threshold.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure, in accordance with one or more various embodiments, is described in detail with reference to the following figures. The figures are provided for purposes of illustration only and merely depict typical or example embodiments.

FIG. 1 illustrates a collaborative vehicle repair estimating system according to some embodiments of the disclosed technology.

FIG. 2 illustrates a process for vehicle repair workflow according to some embodiments of the disclosed technology.

FIG. 3 illustrates a vehicle repair workflow automation process according to some embodiments of the disclosed technology.

FIG. 4 illustrates an example model output according to some embodiments of the disclosed technology.

FIGS. 5A-5D are example screenshots that may be generated by the vehicle repair workflow automation tool.

FIG. 5A illustrates an example job overview according to some embodiments of the disclosed technology.

FIG. 5B illustrates a primary repair estimate view that may be generated by the vehicle repair workflow automation tool according to some embodiments of the disclosed technology.

FIG. 5C illustrates a repair document view that may be generated by the vehicle repair workflow automation tool according to some embodiments of the disclosed technology.

FIG. 5D illustrates a screen for navigation of repair documents view that may be generated by the vehicle repair workflow automation tool according to some embodiments of the disclosed technology.

FIG. 6 shows an example vehicle repair procedure as ingested by the NLP machine learning model according to some embodiments of the disclosed technology.

FIG. 7 is an example computing component that may be used to implement various features of embodiments described in the present disclosure.

The figures are not exhaustive and do not limit the present disclosure to the precise form disclosed.

### DETAILED DESCRIPTION

With the advent of high-power, cost effective computing systems came the increased automation of numerous facets of our contemporary society. In the insurance and other casualty and loss industries, for example, computerized claims estimating, processing, tracking and payment systems have long been in use to streamline processes and to expedite claims handling and closure.

Despite these advances, vehicle repair remains a long and tedious process, requiring input and review from multiple parties involved in the estimating and repair workflow, often involving the review of lengthy original equipment manufacturer documents such as vehicle specifications that may number in the tens of thousands of pages. In some cases, such reviews lead to flawed repair procedures, which may include vague instructions, unnecessary steps, and the like. And in some cases this process produces flawed estimates, for example including excessive costs for certain lines of the estimate. These flaws are often spotted by skilled reviewers such as insurance adjusters.

In this description, various embodiments are disclosed for vehicle repair workflow automation. However, embodiments of the disclosed technology apply to other processes as well. For example, embodiments may apply to generating estimates for medical procedures, and the like. These and other applications will be apparent to one skilled in the relevant art after reading this description. Before describing embodiments of the disclosed technology in detail, it is useful to describe an example environment in which the disclosed technology may be implemented.

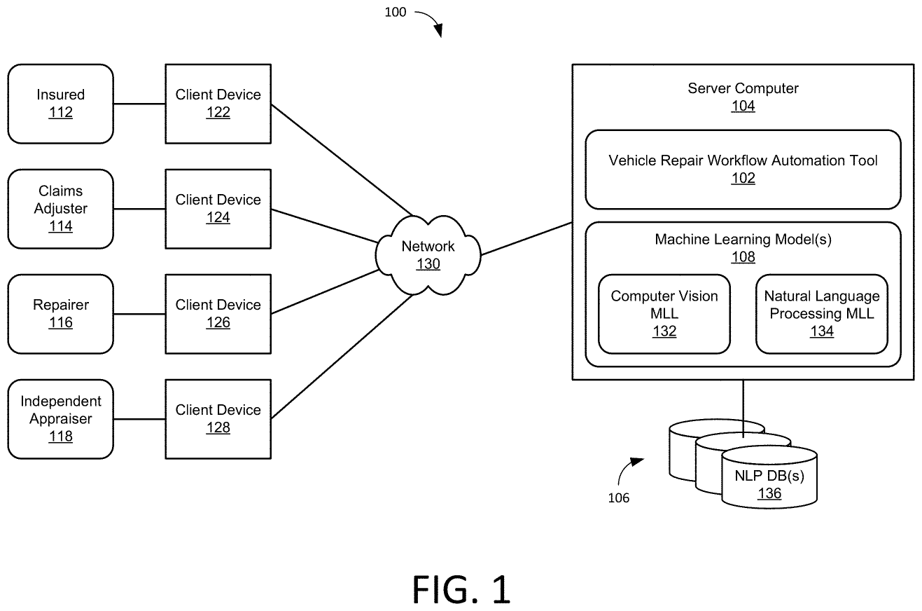

FIG. 1 illustrates an vehicle repair workflow automation system 100 according to some embodiments of the disclosed technology. Multiple users may be involved in the vehicle repair workflow. For example, referring to FIG. 1, the users may include the insured 112, a claims adjuster 114, a repairer 116 such as an employee of a repair shop, an independent appraiser 118, and the like. Each user may employ a respective client device 122, 124, 126, 128. Each client device may be implemented as a desktop computer, laptop computer, smart phone, smart glasses, embedded computers and displays, diagnostic devices and the like.

The system 100 may include a vehicle repair workflow automation tool 102, which may be implemented as one or more software packages executing on one or more server computers 104. Each user may employ a respective client device 122, 124, 126, 128 to access the tool 102 over a network 130 such as the Internet.

The system 100 may include one or more machine learning models (MLL) 108. For example, the machine learning models 108 may include a computer vision machine learning model 132, a natural language processing machine learning model 134, and the like. The system 100 may include one or more databases 106, which may store vehicle repair procedures, completed estimates, estimates in process, data regarding parts, part costs, labor, labor costs, and the like. The databases 106 may include one or more natural language processing (NLP) databases 136. The natural language processing databases 136 may include rules, documents, and the like for use with the natural language processing machine learning model 134.

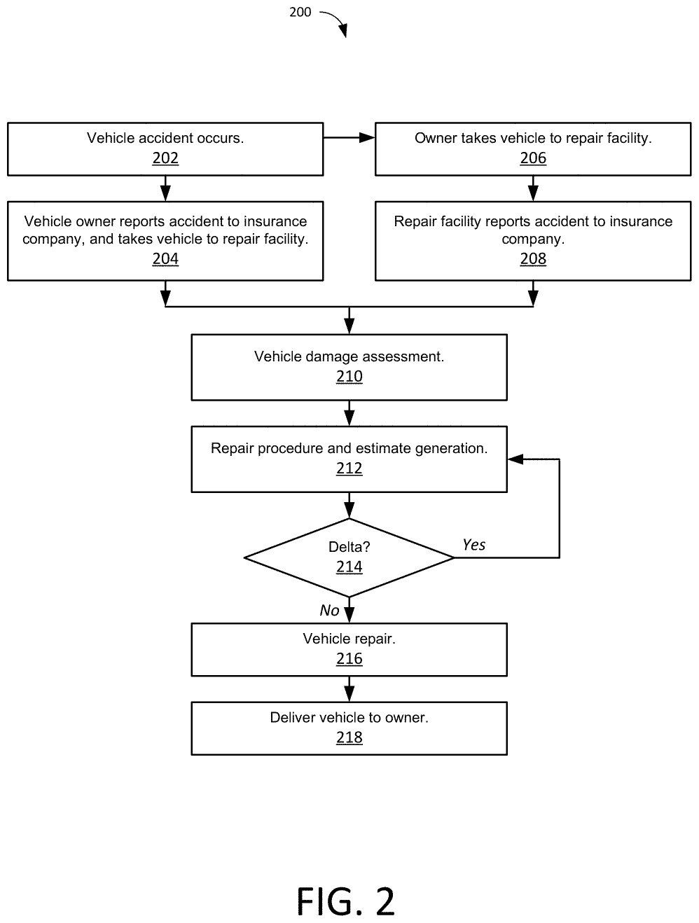

FIG. 2 illustrates a process 200 for vehicle repair workflow according to some embodiments of the disclosed technology. The elements of the disclosed processes are presented in a particular order. However, it should be understood that, in various embodiments, one or more elements may be performed in a different order, in parallel, or omitted. Referring to FIG. 2, the process 200 may begin with a vehicle accident, at 202, and may continue with the vehicle owner reporting the accident to an insurance company, and taking the vehicle to a repair facility, at 204. Alternatively, the owner may take the vehicle to a repair facility, at 206, which may report the accident to the insurance company, at 208.

Next, a vehicle damage assessment is performed, at 210. For example, a staff appraiser of an insurance company may visit the damaged vehicle to take photos of the damage. Alternatively, the owner may send photos of the damaged vehicle to the insurance company. Next, the process may include the generation of vehicle repair procedures, vehicle repair estimates, and the like, at 212. This step may employ one or more machine learning models, for example as described in detail below.

During review of the vehicle repair estimate, a “delta” may occur, at 214. That is, one or more of the reviewers, for example such as an estimator, may disagree with some or all of the repair estimate. When a delta occurs, the process 200 may return to the generation of vehicle repair procedures, vehicle repair estimates, and the like, at 212, and may include generating a supplement estimate. When no additional deltas occur, at 214, the repair of the vehicle may take place, at 216, and the repaired vehicle may be delivered to the vehicle owner, at 218.

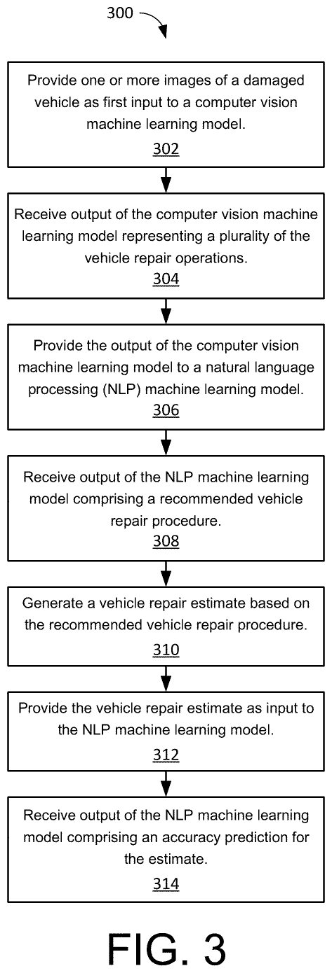

FIG. 3 illustrates a vehicle repair workflow automation process 300 according to some embodiments of the disclosed technology. The process 300 may be performed, for example, by the vehicle repair estimating system 100 of FIG. 1. Referring to FIG. 3, the process may include providing one or more images of the damaged vehicle as input for a trained computer vision machine learning model, at 302. The trained computer vision machine learning model may be implemented, for example, as the trained computer vision machine learning model 132 of FIG. 1. The machine learning model may be trained, for example, with images of other damaged vehicles and the corresponding vehicle repair operations applied to repair those vehicles. Each of the vehicle repair operations may represent the repair or replacement of a vehicle component.

Referring again to FIG. 3, the process 300 may include receiving output of the computer vision machine learning model, at 304. The output may represent a plurality of vehicle repair operations. In some embodiments, the output may include a plurality of values, where each of the values corresponds to a vehicle repair operation.

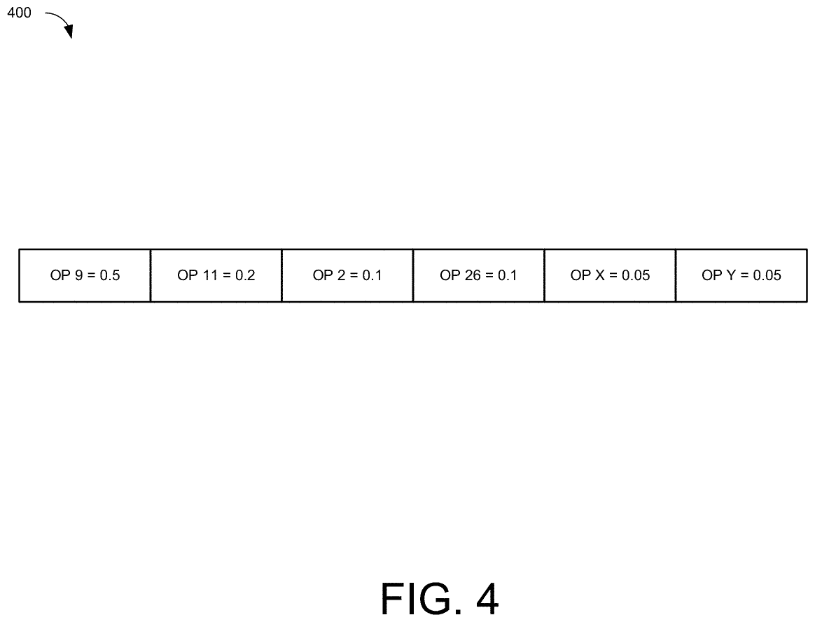

FIG. 4 illustrates an example model output 400 according to some embodiments of the disclosed technology. Referring to FIG, 4, the example output 400 may include six vehicle operations. In the example of FIG. 4, each of the six vehicle operations is represented by a respective operation code, namely OP 9, OP 11, OP 2, OP 26, OP X, and OP Y. The example output 400 may include a respective floating-point value, as shown in FIG. 4. In some embodiments, the six values sum to one (1). However, other value representations and sums are contemplated. The six vehicle operations in the example output 400 may represent the most likely vehicle operations predicted by the model, with likelier vehicle operations represented by higher floating-point values.

Referring again to FIG. 3, the process 300 may include providing the first output of the computer vision machine learning model to a natural language processing (NLP) machine learning model, at 306. The trained NLP machine learning model may be implemented, for example, as the trained NLP machine learning model 134 of FIG. 1. In some embodiments, the NLP machine learning model has been trained with vehicle repair content. The vehicle repair content may include vehicle specifications, vehicle repair procedures, position statements, parts catalogs, and the like. The NLP machine learning model may ingest and process the vehicle repair content to generate machine learning rules and processed NLP content databases. The NLP machine learning model may further curate the ingested vehicle repair content through other artificial intelligence technologies including image analysis, text mining, deep analysis, and the like.

The process 300 may include receiving output of the NLP machine learning model responsive to the input, at 308. In some embodiments, the output may comprise a recommended procedure. In some embodiments, the NLP machine learning model may determine the recommended vehicle repair operation according to all or part the process that follows.

The NLP machine learning model may determine a confidence metric based on the values output by the computer vision model. Determining the confidence metric may include obtaining a difference between the two highest values in the set of values output by the model. Continuing the example of FIG. 4, the two highest values correspond to the vehicle operations OP 9 and OP 11, for a difference of 0.5−0.2=0.3. However, other methods of calculating confidence metrics are contemplated.

The NLP machine learning model may compare the confidence metric with a confidence threshold value. When the confidence metric falls below the confidence threshold value the NLP machine learning model may not select a recommended vehicle repair operation. In the example of FIG. 1, the vehicle repair estimating system 100 may indicate it cannot make a prediction for this particular vehicle operation. But when the confidence metric exceeds the confidence threshold value, the NLP machine learning model may select the vehicle repair operation corresponding to the highest value in the set of model output values as the recommended vehicle repair operation. Continuing the example of FIG. 4, when the confidence threshold is above 0.3, the NLP machine learning model may select the vehicle operation OP 9 because its value of 0.5 is the highest value in the set of values output by the computer vision machine learning model.

Referring again to FIG. 3, the process 300 may include generating a vehicle repair estimate based on the recommended vehicle repair operation, at 310. For example, a user may employ the vehicle repair workflow automation tool 102 to generate one or more lines of the vehicle repair estimate. The line(s) may include a description of the recommended vehicle repair operation, an estimated cost of the recommended vehicle repair operation, and the like.

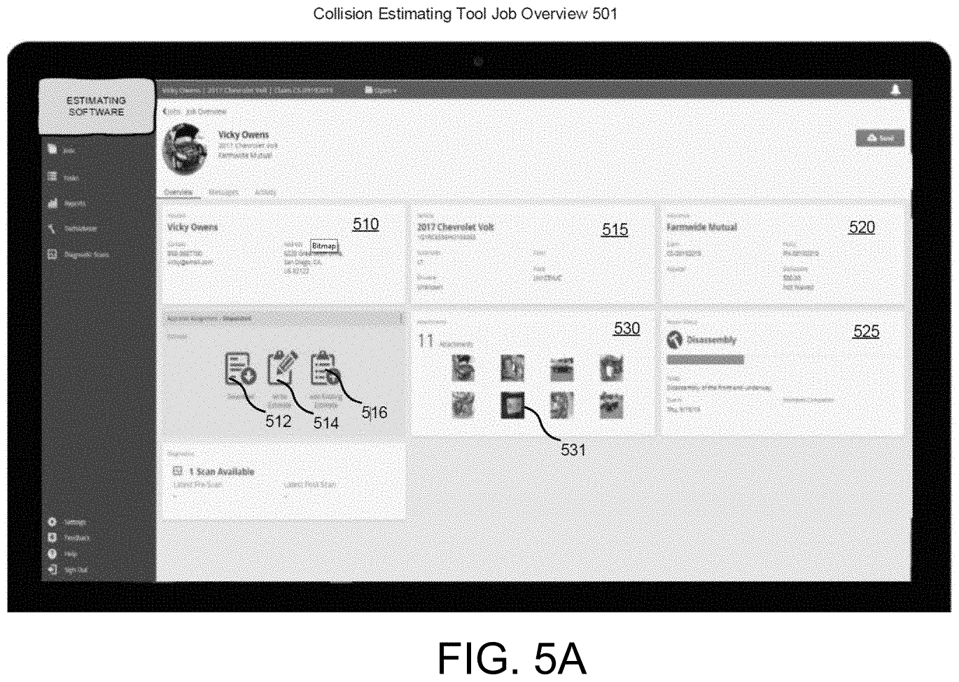

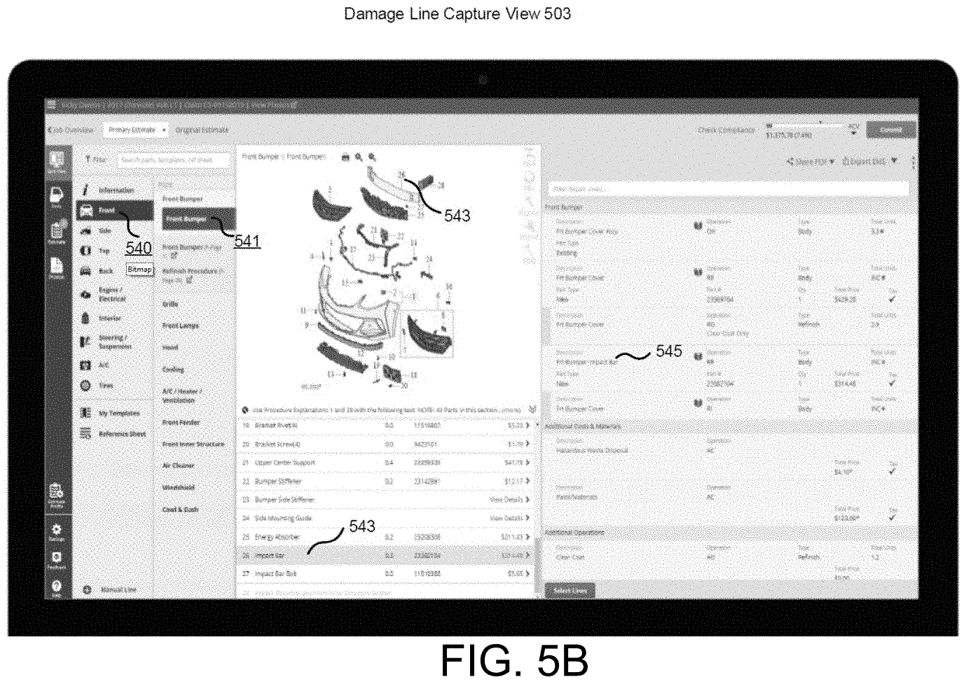

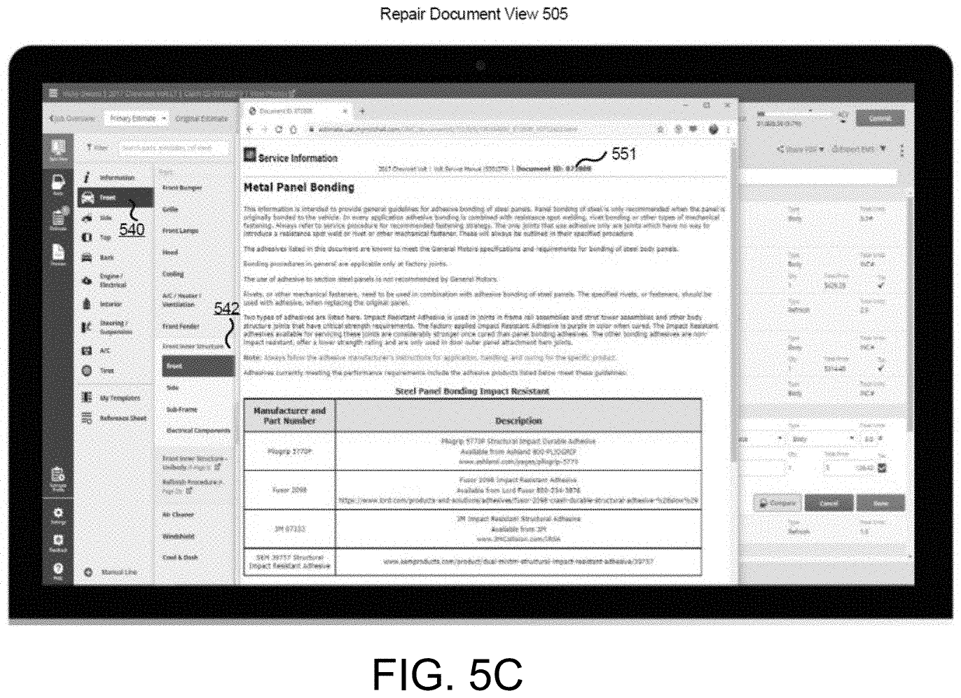

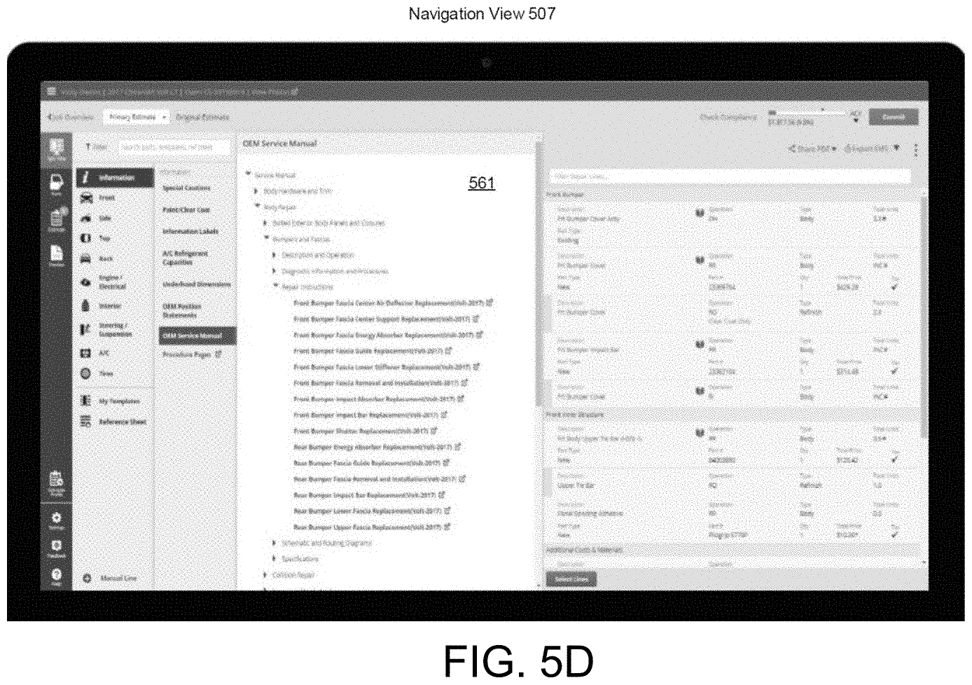

FIGS. 5A-5D are example screenshots that may be generated by the vehicle repair workflow automation tool 102. FIG. 5A illustrates an example job overview 501 according to some embodiments of the disclosed technology. Referring to FIG. 5A, the job overview 501 may provide information describing the vehicle, the vehicle owner, the vehicle owner's insurance policy, the repair status of the vehicle, any attachments associated with the estimate, and the like. For example, a vehicle owner information screen 510 may show the vehicle owner's name, address, contact information, and the like. A vehicle information screen 515 may show the year, make, and model of the vehicle, as well as the submodel, color, license plate number, whether the vehicle is drivable, and the like. An insurance information screen 520 may show the policy number, claim number, deductible amounts, contact information for the claim adjuster, and the like. A repair status screen 525 may show when the vehicle is due into the auto repair shop, when the repair is estimated to be complete, and the like. An attachment information screen 530 may show photos 531 of the vehicle, a summary of the owner's insurance policy, and the like. The vehicle repair workflow automation tool 102 may allow a user to download an existing estimate by clicking the “Download” button 512, to begin writing an estimate by clicking the “Write Estimate” button 514, or to add to an existing estimate by clicking the “Add Existing Estimate” button 516.

FIG. 5B illustrates a primary repair estimate view 503 that may be generated by the vehicle repair workflow automation tool 102 according to some embodiments of the disclosed technology. In this view 503, a user has added several lines to the repair estimate. This example will focus on the line for “Impact Bar”, indicated at 541, shown as added to the estimate as repair line 543.

FIG. 5C illustrates a repair document view 505 that may be generated by the vehicle repair workflow automation tool 102 according to some embodiments of the disclosed technology. In this view 505, a user may view an OEM service manual in window 551. This view shows a repair document for a “Front” section of the vehicle, at 540, which is a sub-section of “Front Inner Structure,” as indicated at 542.

FIG. 5D illustrates a screen for navigation of repair documents view 507 that may be generated by the vehicle repair workflow automation tool 102 according to some embodiments of the disclosed technology. In this view 507, a user can view an OEM service manual in window 561.

In some embodiments, the NLP machine learning model may be used to review specific vehicle repair procedures contained in the vehicle repair estimate. Referring again to FIG. 3, the process 300 may include providing the vehicle repair estimate as input to the NLP machine learning model, at 312, and receiving output of the NLP machine learning model responsive to the input, at 314. The output of the NLP machine learning model may comprise an accuracy score for the estimate. The accuracy score may indicate whether a line of the estimate ingested by the NLP machine learning model is accurate or not accurate. Inaccurate lines of the estimate may be flagged for review.

In some embodiments, the accuracy score may indicate whether a line of the estimate is necessary. For example, while the estimate indicates a test drive need not be performed after the replacement of a front radar sensor of a vehicle, the accuracy score may indicate the test drive is necessary. In some embodiments, the accuracy score may indicate whether a cost of a line of the estimate is above a corresponding predetermined threshold.

In some embodiments, the output of the NLP machine learning model may include a vehicle repair procedure. The vehicle repair procedure output by the NLP machine learning model may differ from the corresponding vehicle repair procedure ingested by the NLP machine learning model. For example, the vehicle repair procedure output by the NLP machine learning model may clarify vague instructions, omit unnecessary steps, and the like.

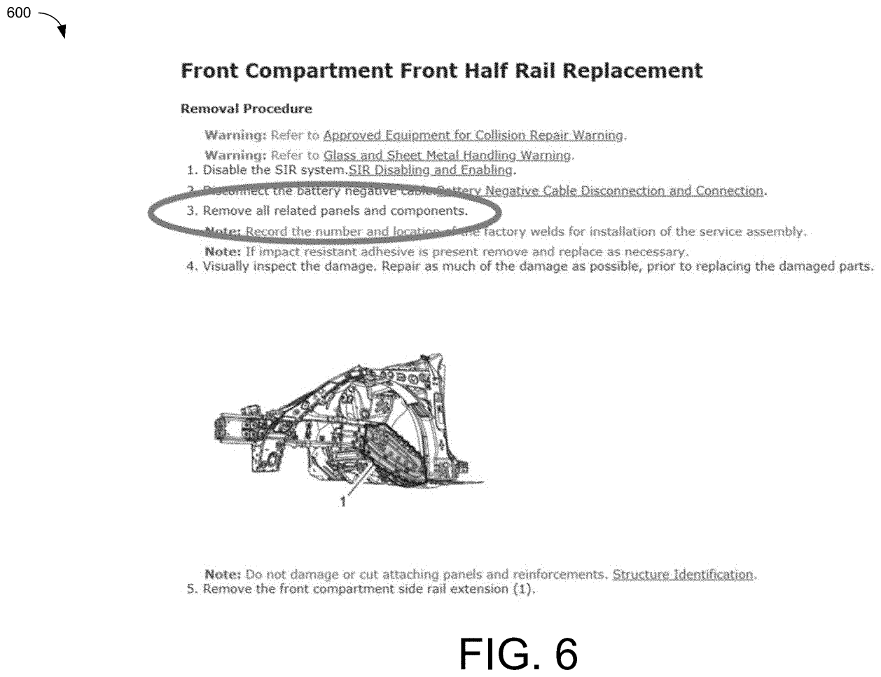

FIG. 6 shows an example vehicle repair procedure 600 as ingested by the NLP machine learning model according to some embodiments of the disclosed technology. The vehicle repair procedure 600 is for the replacement of the front compartment front half rail of a vehicle. The procedure 600 includes 5 steps. Step number 3, which reads “Remove all related panels and components”, is quite vague. In this example, the vehicle repair procedure output by the NLP machine learning model may specify exactly which panels and components must be removed, in which order, and may include diagrams and specific instructions for the removals.

Various embodiments may train one or more of the disclosed machine learning models using supervised machine learning, unsupervised machine learning, and combinations thereof. In supervised machine learning, given some data collected over the past, one can predict an output from an algorithm given an input. This can be written as:

f(X)=y,

where f is the learning (algorithm) function. The algorithm learns the distribution of X data that maximizes the probability of y. However, in a real world production environment X data changes over time, and changes because of the learning algorithm.

Machine learning may include reinforcement learning (RL). RL features an Environment, which in the disclosed embodiments is the real world. RL also features an Agent which acts in the Environment. The Environment provides a reward signal that the Agent uses to maximize some objective reward function. In supervised learning, the Environment and Agent are used, but the reward function is not used.

Embodiments of the disclosed technology may provide several advantages compared with previous solutions. For example, the disclosed technology may improve the accuracy of vehicle repair estimates, resulting in fewer disagreements among reviewers of the estimate, thereby providing a more streamlined vehicle repair workflow. As another example, the disclosed technology may improve the clarity of vehicle repair procedures for repair technicians, thereby improving the quality of the repairs, while also reducing the required time and costs of the repairs.

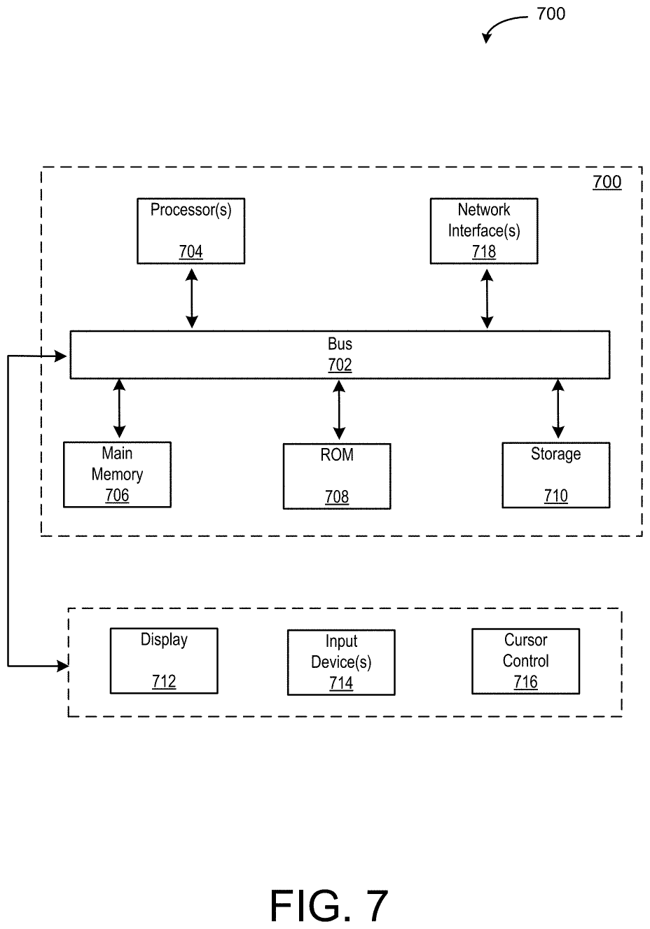

FIG. 7 depicts a block diagram of an example computer system 700 in which embodiments described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a liquid crystal display (LCD) (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. In some embodiments, the same direction information and command selections as cursor control may be implemented via receiving touches on a touch screen without a cursor.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C, C++, and Python. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

The computer system 700 also includes a communication interface 718 coupled to bus 702. Network interface 718 provides a two-way data communication coupling to one or more network links that are connected to one or more local networks. For example, communication interface 718 may be an integrated services digital network (ISDN) card, cable modem, satellite modem, or a modem to provide a data communication connection to a corresponding type of telephone line. As another example, network interface 718 may be a local area network (LAN) card to provide a data communication connection to a compatible LAN (or a WAN component to communicate with a WAN). Wireless links may also be implemented. In any such implementation, network interface 718 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 718, which carry the digital data to and from computer system 700, are example forms of transmission media.

The computer system 700 can send messages and receive data, including program code, through the network(s), network link and communication interface 718. In the Internet example, a server might transmit a requested code for an application program through the Internet, the ISP, the local network and the communication interface 718.

The received code may be executed by processor 704 as it is received, and/or stored in storage device 710, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, or a combination of hardware and software. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 700.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system, comprising:
a hardware processor; and
a non-transitory machine-readable storage medium encoded with instructions executable by the hardware processor to perform a method comprising:
providing one or more images of a damaged vehicle as first input to a computer vision machine learning model, wherein the computer vision machine learning model has been trained with images of other damaged vehicles and corresponding vehicle repair operations;
receiving first output of the computer vision machine learning model responsive to the first input, wherein the first output represents a plurality of the vehicle repair operations;
providing the first output of the computer vision machine learning model to a natural language processing (NLP) machine learning model, wherein the NLP machine learning model has been trained with vehicle repair content comprising a plurality of vehicle repair procedures; and
receiving second output of the NLP machine learning model responsive to the second input, wherein the second output comprises a recommended one of the plurality of the vehicle repair procedures.

2. The system of claim 1, the method further comprising:
generating a vehicle repair estimate based on the recommended one of the plurality of the vehicle repair procedures.

3. The method of claim 1, the method further comprising:
providing the vehicle repair estimate as third input to the NLP machine learning model; and
receiving third output of the NLP machine learning model responsive to the third input, wherein the third output comprises an accuracy score for the estimate.

4. The method of claim 1, wherein:
the accuracy score indicates whether a line of the estimate is accurate or not accurate.

5. The method of claim 1, wherein:
the accuracy score indicates whether a line of the estimate is necessary.

6. The method of claim 1, wherein:
the accuracy score indicates whether a cost of a line of the estimate is above a corresponding predetermined threshold.

7. The method of claim 1, wherein:
the third output of the NLP machine learning model comprises a vehicle repair procedure.

8. A non-transitory machine-readable storage medium encoded with instructions executable by a hardware processor of a computing component, the machine-readable storage medium comprising instructions to cause the hardware processor to perform a method comprising:
providing one or more images of a damaged vehicle as first input to a computer vision machine learning model, wherein the computer vision machine learning model has been trained with images of other damaged vehicles and corresponding vehicle repair operations;
receiving first output of the computer vision machine learning model responsive to the first input, wherein the first output represents a plurality of the vehicle repair operations;
providing the first output of the computer vision machine learning model to a natural language processing (NLP) machine learning model, wherein the NLP machine learning model has been trained with vehicle repair content comprising a plurality of vehicle repair procedures; and
receiving second output of the NLP machine learning model responsive to the second input, wherein the second output comprises a recommended one of the plurality of the vehicle repair procedures.

9. The non-transitory machine-readable storage medium of claim 8, the method further comprising:
generating a vehicle repair estimate based on the recommended one of the plurality of the vehicle repair procedures.

10. The non-transitory machine-readable storage medium of claim 8, the method further comprising:
providing the vehicle repair estimate as third input to the NLP machine learning model; and
receiving third output of the NLP machine learning model responsive to the third input, wherein the third output comprises an accuracy score for the estimate.

11. The non-transitory machine-readable storage medium of claim 8, wherein:
the accuracy score indicates whether a line of the estimate is accurate or not accurate.

12. The non-transitory machine-readable storage medium of claim 8, wherein:
the accuracy score indicates whether a line of the estimate is necessary.

13. The non-transitory machine-readable storage medium of claim 8, wherein:
the accuracy score indicates whether a cost of a line of the estimate is above a corresponding predetermined threshold.

14. The non-transitory machine-readable storage medium of claim 8, wherein:
the third output of the NLP machine learning model comprises a vehicle repair procedure.

15. A computer-implemented method comprising:
providing one or more images of a damaged vehicle as first input to a computer vision machine learning model, wherein the computer vision machine learning model has been trained with images of other damaged vehicles and corresponding vehicle repair operations;
receiving first output of the computer vision machine learning model responsive to the first input, wherein the first output represents a plurality of the vehicle repair operations;
providing the first output of the computer vision machine learning model to a natural language processing (NLP) machine learning model, wherein the NLP machine learning model has been trained with vehicle repair content comprising a plurality of vehicle repair procedures; and
receiving second output of the NLP machine learning model responsive to the second input, wherein the second output comprises a recommended one of the plurality of the vehicle repair procedures.

16. The computer-implemented method of claim 15, further comprising:
generating a vehicle repair estimate based on the recommended one of the plurality of the vehicle repair procedures.

17. The computer-implemented method of claim 15, further comprising:
providing the vehicle repair estimate as third input to the NLP machine learning model; and
receiving third output of the NLP machine learning model responsive to the third input, wherein the third output comprises an accuracy score for the estimate.

18. The computer-implemented method of claim 15, wherein:
the accuracy score indicates whether a line of the estimate is accurate or not accurate.

19. The computer-implemented method of claim 15, wherein:
the accuracy score indicates whether a line of the estimate is necessary.

20. The computer-implemented method of claim 15, wherein:
the accuracy score indicates whether a cost of a line of the estimate is above a corresponding predetermined threshold.
